(19) United States
(12) Patent Application Publication
(10) Pub. No.: US 2008/0011675 A1
(43) Pub. Date: Jan. 17, 2008

(54) POTTING PROCESS FOR MEMBRANE FILTRATION MODULES

(76) Inventor: Eugene Kedziora, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/574,150

(22) PCT Filed: Aug. 23, 2005
(86) PCT No.: PCT/AU05/01265

§ 371 Date: Feb. 23, 2007

(30) Foreign Application Priority Data
Aug. 23, 2004 (AU) 2004904791

(51) Int. Cl. B01D 63/02

(52) U.S. Cl. 210/500.23

(57) ABSTRACT

A process for potting porous hollow membranes (5) including the steps of: providing a potting mould (6) having details (8) formed in its surface to allow co-operation with other components; positioning ends of the membranes in the mould (6); filling the mould (6) with potting material (9); allowing the potting material (9) to at least partially cure; and removing the pot formed from the potting material (9) from the mould (6). A filtration module including a pot formed by the process is also disclosed.

### TECHNICAL FIELD

The present invention relates to a potting process and a pot formed thereby and more particularly to a process and a pot for potting membranes used in filtration systems.

### BACKGROUND OF THE INVENTION

Known potting systems pot the ends of the membranes, usually hollow fibres, in potting material surrounded by a plastic or nylon potting sleeve which is used to retain the potting material as well as provide formations for connection to other element such as headers, manifolds, piping and the like. These formations can take the form of threads, slots, grooves, flanges and the like.

One problem found in most filtration systems is that connections between various components of the system, which are not totally sealed, can lead to ingress of contaminated material, which in turn can lead to unwanted contamination of the filtrate.

This problem can manifest itself in the potting arrangement described above where there is not a tight seal between the potting sleeve and the potting material.

### DISCLOSURE OF THE INVENTION

It is an object of the present invention to overcome or ameliorate at least one of the disadvantages of the prior art, or to provide a useful alternative.

According to the present invention there is provided a process for potting porous hollow membranes including the steps of:

providing a potting mould having details formed in its surface to allow co-operation with other components;

positioning ends of said membranes in said mould;

filling said mould with potting material;

allowing said potting material to at least partially cure; and

removing pot formed from said potting material from said mould.

According to another aspect, the present invention provides a potting process for forming a pot including potting material to sealingly support hollow porous membranes in a filtration module wherein the pot forms a barrier between a feed side and a filtrate side of said membranes and wherein no element forming part of the module is required to retain the potting material.

According to another aspect, the present invention provides a filtration module comprising a pot including potting material to sealingly support hollow porous membranes in said filtration module wherein the pot forms a barrier between a feed side and a filtrate side of said membranes and wherein no element forming part of the module is required to retain the potting material.

Preferably, the pot includes details formed in its surface to allow co-operation with other components. For preference, the other components include elements for mounting the membranes and/or for fluid communication with the membranes.

### BRIEF DESCRIPTION OF THE DRAWINGS

A preferred embodiment of the invention will now be described, by way of example only, with reference to the accompanying drawings in which:

FIG. 1 shows a schematic sectional elevation view of the prior art form of potting mould presently used; and

FIG. 2 shows a similar view to FIG. 1 of the potting mould to be used with the present invention.

### DESCRIPTION OF PREFERRED EMBODIMENT

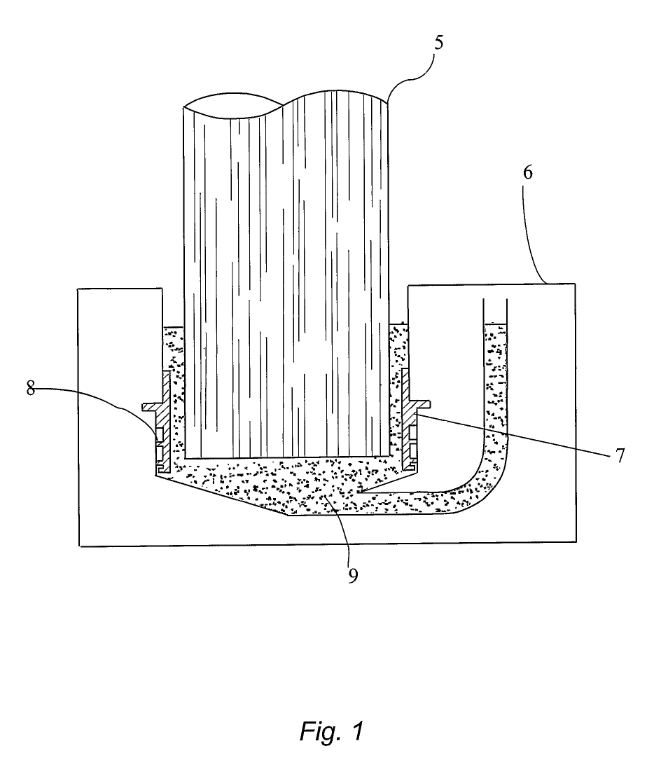

Referring to FIG. 1 of the drawings the known potting method consists of loading a bundle of membranes 5 into a mould 6 containing a potting sleeve 7 having details such as grooves 8 for co-operation with other system components. Potting material 9 is then introduced around the membrane bundle (or vice versa) to thereby creating the pot.

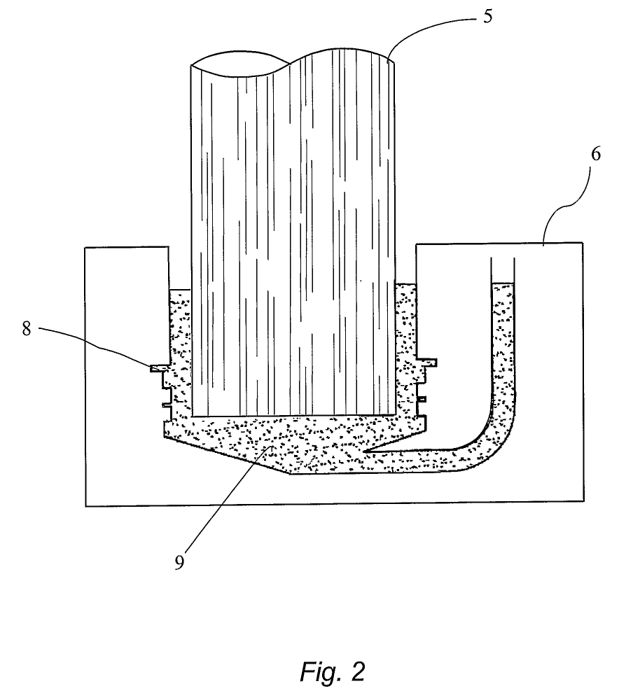

Referring to FIG. 2 showing an embodiment of the potting method according to the invention, the mould 6 does not contain the sleeve 7 and the required details 8 are formed directly into the surface of the mould 6. The potting material 9 is contained by the mould 6 which may have details 8 in its surface such that the potting material 9 takes the negative shape of the mould 6. In this way the details 8 shaped directly on the outside of the pot may be used for connection to other flow, mounting or associated components. An insert (not shown) may be inserted into one of the details 8 to form a protrusion in the mould 6 to provide increased strength to the pot at selected critical points.

The removal of the potting sleeve provides savings in componentry while also avoiding the interface problems between the sleeve and the pot which may lead to contamination of filtrate.

It will be appreciated that further embodiments and exemplifications of the invention are possible without departing from the spirit or scope of the invention described.

1. A process for potting porous hollow membranes comprising the steps of:
providing a potting mould having details formed in its surface to allow co-operation with other components;
positioning ends of said membranes in said mould;
filling said mould with potting material;
allowing said potting material to at least partially cure; and
removing pot formed from said potting material from said mould.

2. A potting process according to claim 1 wherein said other components include elements for mounting said membranes.

3. A potting process according to claim 1 wherein said other components include elements for fluid communication with said membranes.

4. A potting process for forming a pot including potting material to sealingly support hollow porous membranes in a filtration module wherein the pot forms a barrier between a feed side and a filtrate side of said membranes and wherein no element forming part of the module is required to retain the potting material.

5. A filtration module comprising a pot including potting material to sealingly support hollow porous membranes in said filtration module wherein the pot forms a barrier between a feed side and a filtrate side of said membranes and wherein no element forming part of the module is required to retain the potting material.

6. A filtration module according to claim 5 wherein in said pot includes details formed in its surface to allow co-operation with other components.

7. A potting process according to claim 6 wherein said other components include elements for mounting said membranes.

8. A potting process according to claim 6 wherein said other components include elements for fluid communication with said membranes.
